(19) United States
(12) Patent Application Publication
(10) Pub. No.: US 2025/0100330 A1
(43) Pub. Date: Mar. 27, 2025

(54) FORECASTING TIRE TREAD DEPTH

(71) Applicant: Valvoline Licensing and Intellectual Property LLC, Lexington, KY (US)

(72) Inventors: Adam Sworski, Ashland, KY (US); Leslie Noel, Lexington, KY (US); Seth Jessie, Lexington, KY (US)

(21) Appl. No.: 18/891,274

(22) Filed: Sep. 20, 2024

Related U.S. Application Data
(60) Provisional application No. 63/585,047, filed on Sep. 25, 2023.

(51) Int. Cl. B60C 11/24; G01B 11/22

(52) U.S. Cl. CPC B60C 11/246; G01B 11/22

(57) ABSTRACT

Systems and methods for forecasting a depth of a tire tread are provided herein. The system includes a first device, a processing unit, and a second device. The first device measures tire tread depth associated with a customer. The first device communicates with the processing unit to calculate a wear rate. The processing unit uses the calculated wear rate to determine when the depth of the tire tread will decrease below a predetermined threshold, which is communicated to the second device.

### PRIORITY CLAIM AND CROSS-REFERENCE TO RELATED APPLICATIONS

This application claims priority to and benefit of U.S. Provisional Application No. 63/585,047, filed Sep. 25, 2023, the entire contents of which are hereby incorporated by reference in their entirety.

### FIELD

The present disclosure relates generally to systems for forecasting and communicating tire tread depth.

### BACKGROUND

Generally, a tire includes a tread, which is the portion of the tire that contacts the ground. The tread further includes various features, such as grooves or ribs, which may provide improved traction, stability, and water dispersion for a vehicle. However, over extended use, the tire will gradually lose its tread, caused by, for example, friction between the tread and the road. As the tire loses its tread, the performance of the tire may be negatively impacted, which can negatively impact the safety of the vehicle. In one example, a vehicle may be more likely to hydroplane because a tire cannot channel airflow and pass through water without the proper grooves in the tread. Because the tire tread is important for performance and safety, the tire tread is occasionally monitored, and the tire is replaced when the tread is no longer effective.

The depth of the tread, or tire tread depth, is one physical feature associated with the tire that can be used to monitor the overall loss of the tire tread effectiveness. The tire tread depth is the distance between the top of the tread to the bottom of the deepest grove of the tread. The depth of the tire tread can be measured in various ways, including with handheld devices or with automatic systems that are designed for a vehicle to drive over. In an example, a tire tread includes four grooves across the width of the tire. The depth of the tire tread is calculated by measuring each groove at the same position along a circumference of the tire, resulting in four tread measurements per tire. As a result, the process of measuring tire tread depth may provide sixteen individual measurements for a single vehicle with four wheels. It should be appreciated that the number of measurements may vary depending on the number of tires on the vehicle and the number of grooves on each tire. With new tires, the tread depth may be 10/32 to 12/32 inches. But, as noted above, this tread depth will decrease with time, leading to unsafe conditions. Therefore, improved systems for forecasting and communicating tire tread depth are needed.

### SUMMARY

The systems and methods disclosed herein improve on current technology by providing systems and methods for forecasting and communicating tire tread depth.

In light of the disclosure, and without limiting the scope of the invention in any way, in a first aspect of the present disclosure, which may be combined with any other aspect listed herein unless specified otherwise, a system for forecasting a depth of a tire tread is provided. The system includes a first device, a processing unit, and a second device. The first device measures a first depth of the tire tread and a second depth of the tire tread, wherein the first depth of the tire tread and the second depth of the tire tread are associated with a first customer. The processing unit receives the first depth of the tire tread and the second depth of the tire tread, and the processing unit includes an algorithm to determine a wear rate based on the first depth of the tire tread, the second depth of the tire tread, and a plurality of factors associated with the first customer. The processing unit uses the wear rate to forecast when the depth of the tire tread will decrease below a predetermined threshold. The second device is associated with the first customer and receives a message from the processing unit communicating an estimate of when the depth of the tire tread is forecasted to fall below the predetermined threshold.

In a second aspect of the present disclosure, which may be combined with any other aspect listed herein unless specified otherwise, the processing unit includes storage configured to store the first depth of the tire tread and the second depth of the tire tread.

In a third aspect of the present disclosure, which may be combined with any other aspect listed herein unless specified otherwise, the plurality of factors associated with the first customer include a first odometer reading and a second odometer reading. The first odometer reading corresponds to the first depth of the tire tread and the second odometer reading corresponds to the second depth of the tire tread.

In a fourth aspect of the present disclosure, which may be combined with any other aspect listed herein unless specified otherwise, the algorithm determines a correction factor based on a sub-set of the plurality of factors associated with the first customer.

In a fifth aspect of the present disclosure, which may be combined with any other aspect listed herein unless specified otherwise, the correction factor and the initial wear rate correspond to a remaining useful life.

In a sixth aspect of the present disclosure, which may be combined with any other aspect listed herein unless specified otherwise, the correction factor ranges from 0.85 and 1.15.

In a seventh aspect of the present disclosure, which may be combined with any other aspect listed herein unless specified otherwise, the correction factor is updated when the first device measure a third depth of the tire tread.

In an eighth aspect of the present disclosure, which may be combined with any other aspect listed herein unless specified otherwise, the sub-set of the plurality of factors associated with the first customer include at least one of a model of the vehicle and a year of the vehicle.

In a ninth aspect of the present disclosure, which may be combined with any other aspect listed herein unless specified otherwise, the first device is an automatic tread measurement device configured to measure the first depth of the tire tread and the second depth of the tire tread when the vehicle drives over the automatic tread measurement device.

In a tenth aspect of the present disclosure, which may be combined with any other aspect listed herein unless specified otherwise, the first device is a handheld device.

In an eleventh aspect of the present disclosure, which may be combined with any other aspect listed herein unless specified otherwise, a method for forecasting a depth of a tire tread is provided. The method includes the steps of measuring a first depth of the tire tread; measuring a second depth of the tire tread; associating the first depth of the tire tread and the second depth of the tire tread with a first customer; and communicating the first depth of the tire tread and the second depth of the tire tread to a processing unit. The processing unit includes an algorithm to determine a wear rate based on at least the first depth of the tire tread, the second depth of the tire tread, and a plurality of factors associated with the first customer. The method includes the further steps of forecasting, based on the wear rate, when the depth of the tire tread will decrease below a predetermined threshold and communicating to the first customer an estimate of when the depth of the tire tread is forecasted to fall below the predetermined threshold.

In a twelfth aspect of the present disclosure, which may be combined with any other aspect listed herein unless specified otherwise, the method further includes storing the first depth of the tire tread and the second depth of the tire tread in storage of the processing unit.

In a thirteenth aspect of the present disclosure, which may be combined with any other aspect listed herein unless specified otherwise, the plurality of factors associated with the first customer include a first odometer reading and a second odometer reading. The first odometer reading corresponds to the first depth of the tire tread and the second odometer reading corresponds to the second depth of the tire tread.

In a fourteenth aspect of the present disclosure, which may be combined with any other aspect listed herein unless specified otherwise, the algorithm determines a correction factor based on a sub-set of the plurality of factors associated with the first customer.

In a fifteenth aspect of the present disclosure, which may be combined with any other aspect listed herein unless specified otherwise, the correction factor and the initial wear rate correspond to a remaining useful life.

In a sixteenth aspect of the present disclosure, which may be combined with any other aspect listed herein unless specified otherwise, the correction factor ranges from 0.85 and 1.15.

In a seventeenth aspect of the present disclosure, which may be combined with any other aspect listed herein unless specified otherwise, the correction factor is updated when the first device measure a third depth of the tire tread.

In an eighteenth aspect of the present disclosure, which may be combined with any other aspect listed herein unless specified otherwise, the sub-set of the plurality of factors associated with the first customer include at least one of a model of the vehicle and a year of the vehicle.

In a nineteenth aspect of the present disclosure, which may be combined with any other aspect listed herein unless specified otherwise, the first device is an automatic tread measurement device, and wherein the automatic tread measurement device is configured to measure the first depth of the tire tread and the second depth of the tire tread when the vehicle drives over the automatic tread measurement device.

In a twentieth aspect of the present disclosure, which may be combined with any other aspect listed herein unless specified otherwise, the first device is a handheld device.

Additional features and advantages of the disclosed devices, systems, and methods are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein. Moreover, it should be noted that the language used in the specification has been selected for readability and instructional purposes, and not to limit the scope of the inventive subject matter.

### BRIEF DESCRIPTION OF THE FIGURES

Understanding that figures depict only typical embodiments of the invention and are not to be considered to be limiting the scope of the present disclosure, the present disclosure is described and explained with additional specificity and detail through the use of the accompanying figures. The figures are listed below.

FIG. 1 illustrates a diagram of a system for forecasting a depth of a tire tread, according to an example embodiment of the present disclosure.

FIG. 2 illustrates an automatic tread measurement device installed indoors at the entrance of a service bay, according to an example embodiment of the present disclosure.

FIG. 3 illustrates an automatic tread measurement device installed outdoors at the entrance of a service bay, according to an example embodiment of the present disclosure.

FIG. 4 illustrates an automatic tread measurement device installed in a parking lot, according to an example embodiment of the present disclosure.

FIG. 5 illustrates a flow chart diagram for forecasting a depth of a tire tread, according to an example embodiment of the present disclosure.

FIGS. 6A to 6D illustrate prediction error results of a system for forecasting a depth of a tire tread, according to an example embodiments of the present disclosure.

### DETAILED DESCRIPTION

Current technology provides various methods for measuring tire tread depth, which can be used to determine when a tire should be replaced. For example, a handheld device can be used to manually measure the depth of a tire tread. If the depth of the tire tread is below a desired depth, the user may replace the tire. In another example, a user may determine that a tire must be replaced when built-in wear bars indicate that the tire tread has reached an improper depth. Alternatively, a user could rely on the manufacturer warranty period to estimate when the tire should be replaced. While each method may provide an indication of when the tire needs to be replaced, current methods fail to accurately forecast when the tire should be replaced at some future point in time, which would allow a user to plan for the time and resources needed to replace the tire. Current “forecasting efforts,” such as reliance on a manufacturer warranty period, fail to take into account driver-specific factors, which affect tire wear rate. Thus, improved systems for forecasting and communicating tire tread depth are needed.

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specific the presence of stated features, integers, steps, operations, elements, and/or components, but do not preclude the presence or additional of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. When an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent”). The term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

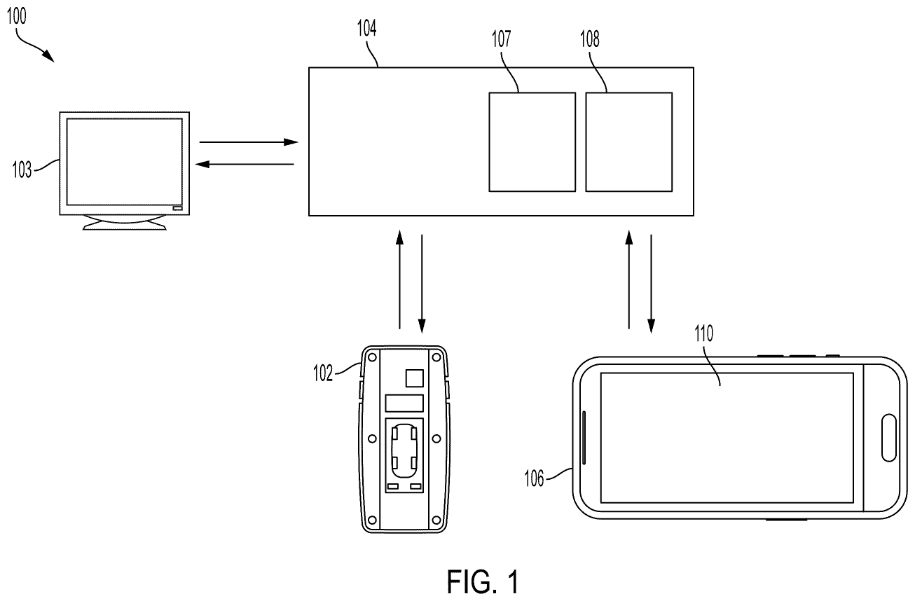

FIG. 1 illustrates a diagram of a system for forecasting a depth of a tire tread, according to an example embodiment of the present disclosure. The system 100 includes a first device 102, a processing unit 104, and a second device 106. In an embodiment, the first device 102 is configured to measure the depth of a tire tread. For example, the first device 102 may include an automatic tread measurement device. The automatic tread measurement device may be a Hunter Quick Check® Unmanned Inspection System (the “Hunter System”) or other similar system.

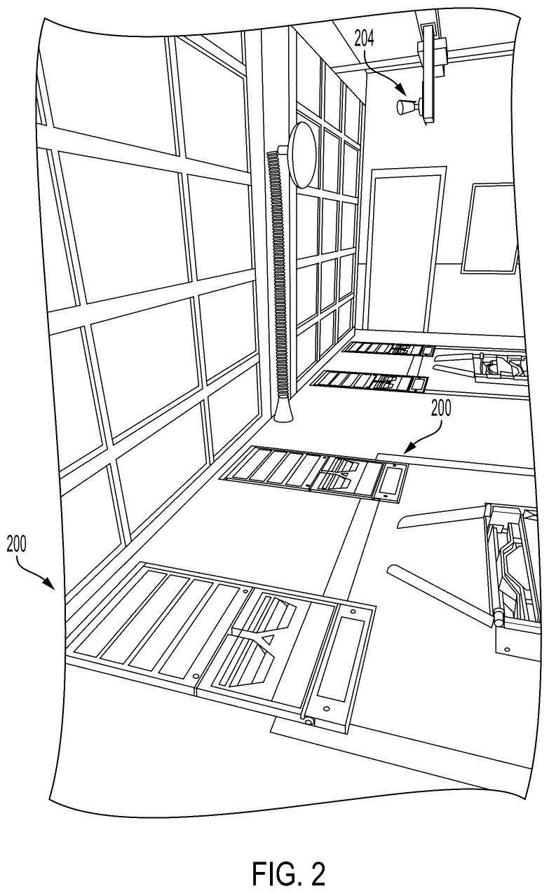

Among various features, the Hunter System can create a three-dimensional map of a vehicle's tire to measure the depth of the tire tread. Further, the Hunter System can be installed in any number of locations, including the floor of an automotive bay in an indoor or outdoor environment, an entrance or exit of a parking lot, or any other area where vehicle traffic meets a desired threshold. The installation location must meet tread equipment manufacturers installation requirements. For example, the automatic tread measurement device may require the vehicle to be straight and square when passing over the automatic measurement device, as well as having a speed between maximum and minimum threshold. In use, a vehicle drives over the automatic tread measurement device, which will measure tire tread depth. Examples of an automatic tread measurement device are shown and described in reference to FIGS. 2 to 5.

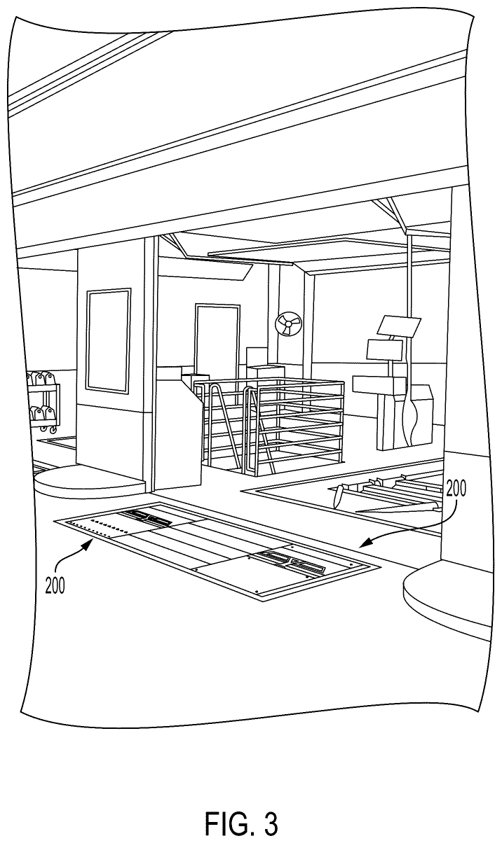

FIG. 2 illustrates an automatic tread measurement device installed indoors at the entrance of a service bay. As shown in FIG. 2, the automatic tread measurement device 200 is located indoors at the entrance of a service bay. Further, the automatic tread measurement device 200 is mounted flush with the ground. Therefore, as a vehicle enters the service bay, the automatic tread measurement 200 may measure the treads of the vehicle. The automatic tread measurement device 200 may also be installed in pairs to measure the tires on each side of the vehicle. The service bay may include any number of additional features to facilitate data collection. For example, the service bay may include a mounted camera 204 configured to collect various information of vehicles entering the service bay, including license plate number and the model of the vehicle. As shown in FIG. 3, the automatic tread measurement device may also be installed outdoors at the entrance of a service bay. The description of the automatic tread measurement device 200 in FIG. 2 also applies to the automatic tread measurement device 200 in FIG. 3.

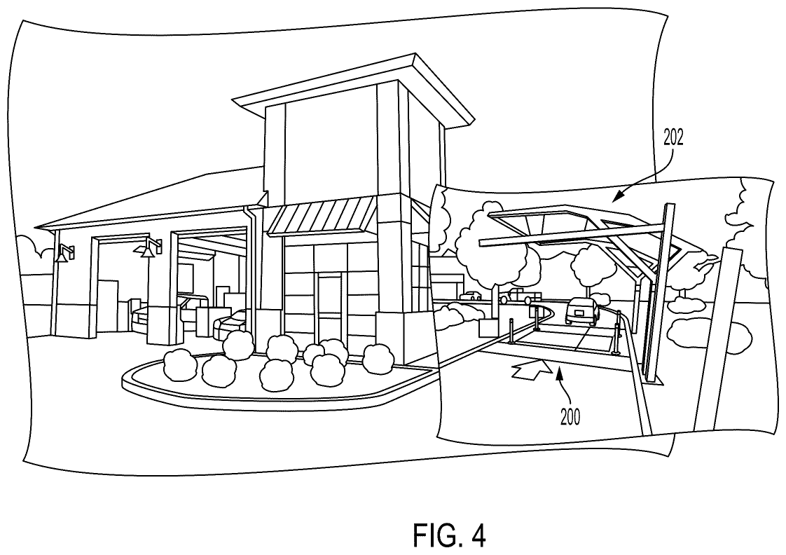

FIG. 4 illustrates an automatic tread measurement device installed in a parking lot. As shown in FIG. 4, the automatic tread measurement device 200 is installed in a drive through portion of a parking lot. The installation method may further include a canopy protection 202 to cover the automatic tread measurement device 200, thereby protecting the automatic tread measurement device 200 from the outdoor elements. In various embodiments, the automatic tread measurement device may be mounted flush with the ground or provide an elevated surface mount.

Referring to FIG. 1, the first device 102 may also be a handheld device for measuring the depth of a tire tread. Namely, a user may measure the depth of each groove on the tire. Thus, if the tire tread includes four grooves, four separate measurements will be provided. Further, four separate measurements may be provided for each tire, resulting in sixteen measurements total. These sixteen measurements can then be averaged to provide a single value for the tire tread depth. By averaging such measurements, the impact from measurement variability and changes in groove depth due to tire rotations can be minimized. As a result, a more accurate tire tread depth may be determined. The handheld device may be any number of devices, including a Groove Glove, an Autel Tire Tread Wand, or a smart phone having a tread scanner.

In an example, Table I provides a comparison between several vehicle specific models when using an average tire tread depth versus a minimum tire tread depth for forecasting. As shown below, a model may forecast more accurately when using an average tire tread depth versus a minimum tire tread depth.

TABLE 1

| | R²-Minimum | R²-Average | |
|---|---|---|---|
| Vehicle Model | Tread | Tread | Improvement |
| Ford F-150 | 0.8007 | 0.9112 | 13.8% |
| Chevy Silverado | 0.8068 | 0.9120 | 13.0% |
| Ram 1500 | 0.7704 | 0.8779 | 14.0% |
| Toyota Camry | 0.8063 | 0.9211 | 14.2% |

It should be appreciated that these examples are not limiting, and, in other embodiments, the first device 102 may be any number of devices for manually or automatically measuring the depth of a tire tread. The first device 102 may include several independent means of measuring the depth of a tire tread, such as both an automatic and manual device. Further, the installation of the first device 102 can be customized based on the application.

As previously noted, the system 100 further includes the processing unit 104. The processing unit 104 receives and stores data collected by the first device 102. Namely, the first device 102 measures a first depth of a tire tread and a second depth of a tire tread, which are associated with a first customer. The first depth of the tire tread and the second depth of the tire tread are then communicated to the processing unit 104. In an example, the first device 102 transmits the data to the processing unit 104. The processing unit 104 can take any number of forms. In an example, the processing unit 104 is a remote server that is accessible over the Internet. In other words, the system 100 may rely on cloud computing as its processing unit 104. Using cloud computing, the processing can be completed at a location remote from the location at which the tire tread depth is collected. The processing unit 104 may be separately maintained and operated by the automotive maintenance center or a vendor of the automotive maintenance center. In another embodiment, the processing unit 104 may be located on the vehicle, which may further include a telematics control unit (“TCU”) for supplying data for the system 100.

In an example, the first depth of the tire tread and the second depth of the tired tread are communicated to a vendor cloud. Then, the vendor cloud sends the data to the processing unit 104, which is operated by the automotive maintenance center. The vendor cloud may send, for example, the data in real-time via application programming interface (“API”) or with a daily export file. The processing unit 104 may be centrally located. Through its central location, the processing unit 104 can receive data collected in any automotive maintenance center.

The processing unit 104 includes storage 107 and an algorithm 108. Once the data is collected by the first device 102, the data is transmitted to the processing unit 104 and stored in the storage 107. Then, the processing unit 104 may filter and transmit the data to the algorithm 108. The algorithm 108 determines a wear rate based on the first depth of the tire tread, the second depth of a tire tread, and a plurality of factors associated with the first customer. The plurality of factors associated with the first customer may affect how quickly the tire tread depth decreases.

In an example, the algorithm 108 uses the first depth of the tire tread, the second depth of the tire tread, a first odometer reading, and a second odometer reading to calculate the wear rate. The first and second odometer readings are recorded at the respective times at which the measurements are taken of the first depth of the tire tread and the second depth of the tire tread. Thus, from such data, the algorithm 108 can determine a wear rate in the form of a rate of decrease in the tire tread over distance traveled. In an alternative embodiment, the algorithm 108 of the processing unit 104 determines a wear rate based on the first depth of the tire tread and a plurality of factors associated with the first customer. In other words, while a second depth of a tire tread may be desired for increased accuracy, the system 100 does not require a second depth of the tire tread to calculate the wear rate of the tire tread depth.

In an example embodiment, the algorithm 108 calculates an initial wear rate based on a sub-set of the plurality of factors associated with the first customer, which may include the vehicle make, the vehicle model, the vehicle year, the vehicle weight, the vehicle identification number, the vehicle ownership information, the date of the visit, and the tire replacement history. The sub-set of the plurality of factors may further include the geographic region in which the first customer is located, typical weather patterns in said geographic region, typical elevation profiles in said geographic region, driver demographic information, type of ownership (e.g., fleet vehicle or consumer vehicle), and type of driving environment (e.g., city or highway). Each of these customer-specific data points may be entered into a data communication device 103 that communicates with the processing unit 104. In an embodiment, the data communication device 103 may also be the first device 102. In other words, the first device 102 may be configured to measure the depth of a tire tread and receive customer-specific data points that are then communicated to the processing unit 104. Alternatively, one or more of these customer-specific data points may already be stored on the processing unit 104 (e.g., in customer records).

In an embodiment, once the initial wear rate is calculated, a correction factor is applied to determine the remaining useful life (“RUL”). This process may be reflected as the formula of RUL=f(rate)*(cF), where f(rate) represents the initial wear rate and (cF) represents the correction factor. The correction factor uses a sub-set of the plurality of factors to account for the driver behavior, vehicle dynamics, and tire design. Tire design may include the type of tire, various rating scores, or manufacturer. Thus, the final wear rate may be unique to the vehicle and the first customer by considering the previously measured tread depth data and the plurality of factors associated with the first customer. As applied to the RUL formula, a correction factor of one would not affect the initial wear rate. A maximum correction factor and the minimum correction factor may also be defined. In an example, the maximum correction factor is 1.15 and the minimum correction factor is 0.85. In addition to the remaining useful life, the algorithm 108 may additionally output the vehicle identification number associated with the remaining useful life and the average mileage accumulation rate of the vehicle.

It should be appreciated that processing unit 104 (being remote from first device 102) has access to the first customer's vehicle information and driving dynamics but could also consider vehicle information and/or driving dynamics associated with other vehicles (i.e., across a network of first devices 102, such as at a number of different service centers in different physical locations). This network-wide system of data acquisition and processing provides for improved data sets, thus improving the accuracy of the calculated wear rate.

Once the final wear rate is determined, the processing unit 104 uses the wear rate to forecast when the depth of the tire tread will decrease below a predetermined threshold. In an example, the predetermined threshold represents the minimum depth of the tire tread before the performance or safety of the vehicle is compromised. The predetermined threshold can be set based on any number of factors, which may depend on the tire, the type of vehicle, the function of vehicle, or the driver behavior. For example, tires may be designed to function better in rainy or snowy conditions, and thus include deeper grooves; the predetermined threshold may be larger for such tires, as the safety may be compromised at a different tire tread depth than a tire not designed for specific conditions. In another example, the predetermined threshold may be larger for tires that are used on large commercial vehicles due to performance or regulatory requirements. According to the National Highway Safety Administration (“NHTSA”), tires are deemed legally unsafe when the depth of the tire tread reaches 2/32 inches. In a further example, the Department of Transportation (“DOT”) requires a minimum of 4/32 inches for a steer tire or front-wheel tire.

In another example, driver behavior can be considered when setting a predetermined threshold. For example, if a driver's behavior is classified as “aggressive,” then the predetermined threshold may be set higher. In other words, if a driver is more aggressive, it may be preferred to have a deeper tire tread to account for such behavior. With a greater predetermined threshold, the tires would be replaced more frequently. Furthermore, similar data could be used to forecast, based on wear between treads on each tire, when to rotate a customer's tires. Thus, it should be appreciated that the predetermined threshold can vary between customers and vehicles.

Importantly, system 100 does not merely identify that a tire needs to be replaced; rather, system 100 identifies the dynamic wear rate and forecasts a future point in time whereby the tire needs to be replaced. This gives the individual customer improved visibility as to when tires will need replacing, allowing for improved scheduling, cost allocation, and the like.

The processing unit 104 may be configured to transmit a message to a second device 106 associated with the first customer, forecasting when the depth of the tire tread will fall below the predetermined threshold.

In an example, the second device 106 includes a customer interface 110, which may be in the form of a website portal or a software application that can be downloaded onto a mobile device. Based on the data received from the processing unit 104, the customer interface 110 may display a tire tread forecast. In an illustrative example, the customer interface 110 may define a mileage at which the tires should be replaced (e.g., your tires are due to be replaced in 7,000 miles). Alternatively, the customer interface 110 may provide a period of time, calculated based on how many miles the customer drives during average period (e.g., replace tires in 3 months). However, such tire tread forecast may be displayed in various other forms.

In another example, the second device 106 is a monitor disposed within the service bay. Namely, during routine maintenance, the monitor displays, to the customer, a tire tread forecast. The monitor may display information similar to the customer interface. For example, the tire tread forecast may provide a mileage at which the tires should be replaced (e.g., your tires are due to be replaced in 7,000 miles). The monitor may also provide a period of time, calculated based on how many miles the customer drives during an average period (e.g., replace tires in 3 months). Such tire tread forecast may be displayed in various other forms. The monitor may also provide information unrelated to tire tread forecast, including, but not limited to, date of last oil change, estimated oil change date, vehicle mileage information, and estimated time of service.

Moreover, the tire tread depth forecasting may be dynamic. In other words, each time the customer visits an automotive maintenance center, additional data is collected for the processing unit 104 to transmit to the second device 106. The additional data may be used to adjust the correction factor to provide a more accurate remaining useful life calculation. Thus, the customer interface 110 may display an updated tire tread forecast each time the customer visits an automotive maintenance center. In addition to the tire tread forecast, the customer interface 110 may notify the customer when the tires should, or should almost, be replaced. Thus, rather than a user having to periodically check the user interface 110, the second device 106 may notify the user when, for example, the tire tread depth forecasts that the tires should be replace in 500 miles, 100 miles, or immediately. In addition, the second device 106 may include functions that allow the customer to initiate or schedule an appointment for a tire change.

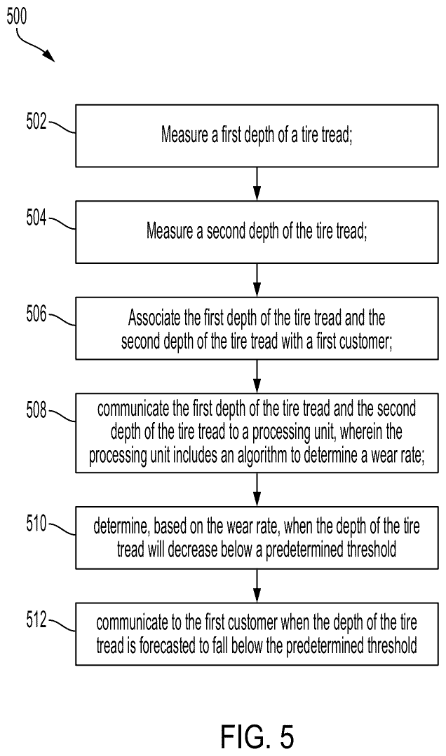

FIG. 5 illustrates a flow chart diagram for forecasting a depth of a tire tread, according to an example embodiment of the present disclosure. The flow chart diagram 500 for forecasting a depth of a tire tread includes measuring a first depth of the tire tread 502 and measuring a second depth of the tire tread 504. The measurement of the first depth of the tire tread and the measurement of the second depth of the tire tread may be taken at different times. For example, a customer may visit an automotive maintenance center regularly to get an oil change. At one oil change, the first depth of the tire tread may be measured. As previously introduced, the first depth of the tire tread may be measured in a variety of ways using a variety of tools. For example, an automotive technician may measure the depth of each groove on the tire using a handheld device. The measurements, which correspond to each groove on each tire, can then be averaged to provide the first depth of the tire tread. Again, by averaging such measurements, the impact from measurement variability and changes in groove depth due to tire rotations can be minimized. As a result, a more accurate tire tread depth may be determined.

Then the customer may return to the automotive maintenance center for a second oil change. At this visit, the second depth of the tire tread may be measured. Similar to the first measurement, the second depth of the tire tread may be measured in a variety of ways using a variety of tools. Further, the second depth of the tire tread does not have to be measured using the same method or tools as the measurement for the first tire tread. By performing first and second measurements at different visits to the maintenance center, the measurements provide additional value in determining the wear rate of the user over a number of miles or a period of time.

In addition, this process can be repeated each time the customer visits the maintenance center, which may lead to a more accurate wear rate calculation. For example, a third depth of the tire tread may be measured, further updating the above process. Overall, the present disclosure does not identify a maximum number of tire tread depth measurements. Instead, additional measurements may increase the accuracy of the forecasting. Thus, the systems and methods described herein can be used in a quick maintenance environment, allowing the tire tread depth to be collected on several occasions. Furthermore, as introduced above, the processing unit 104, which functions to receive data corresponding to the first depth of the tire and the second depth of the tire, may be centrally located. Based on this configuration, the first customer is not required to visit the same location for both the measurement of the second depth of the tire tread and the first depth of the tire tread.

The flow chart diagram 500 includes a step for associating the first depth of the tire tread and the second depth of the tire tread with a first customer 506. This association process can be completed in any of a number of ways. For example, the first customer may be associated with the tire tread depth measurements through personal identification information, such as name, date of birth, or driver license. The first customer may also be associated with the tire tread depth measurements through vehicle information, such as VIN number or license plate number. For example, a camera (as shown in FIG. 2) can be positioned to record and collect the license plate number of a vehicle as it drives over the Hunter System or into an automotive bay. Thus, the tire tread data may be associated with a customer, the vehicle, or a combination of the customer and the vehicle. In an example, a customer may have multiple cars. An association between the tread data with the customer and the specific car of the customer may improve the accuracy of the system. The first depth of the tire tread and the second depth of the tire tread are then communicated to the processing unit 508. This communication step can vary and depend on the first device. For example, the first device may include a transmitter that automatically sends the tire tread depth data to the processing unit. Alternatively, a vehicle technician may communicate the tire tread depth data by, for example, inputting the data into a user interface on an intermediary device that transmits the data to the processing unit.

Once received, the processing unit uses the first depth of the tire tread and the second depth of the tire tread. Namely, the processing unit includes an algorithm to determine a wear rate. The algorithm considers the first depth of the tire tread, the second depth of a tire tread, and a plurality of factors associated with the first customer to determine the wear rate. As discussed in reference to FIG. 1, the algorithm calculates an initial wear rate based on a sub-set of the plurality of factors associated with the first customer, which may include the vehicle make, the vehicle model, and the vehicle weight. Once the initial wear rate is calculated, a correction factor is applied. The correction factor also uses a sub-set of the plurality of factors to account for the driver behavior, vehicle dynamics, and tire design. Thus, the final wear rate may be unique to the vehicle and the first customer by considering the previously measured tread depth data and plurality of factors associated with the first customer.

Once the final wear rate is determined, it can be used to determine when the depth of the tire tread will decrease below a predetermined threshold 510. Again, as discussed above, the predetermined threshold can be set based on any number of factors, which may depend on the tire, the type of vehicle, or the function of vehicle. Thus, it should be appreciated that the predetermined threshold can vary between customers or vehicles. A message can then be communicated to the first customer forecasting when the depth of the tire tread will fall below the predetermined threshold 512.

The following paragraph provides an illustrative example of the flow chart diagram for forecasting a depth of a tire tread in FIG. 5. A customer visits an automotive maintenance center, which is a first visit. During this visit, the tread depth of the tire is measured. Then, the customer leaves the automotive center. The customer returns, for example, when their vehicle requires an oil change. During this second visit, the tread depth of the tire is again measured. These measurements (from the first visit and from the second visit) are associated with the first customer and then communicated to a processing unit. The processing unit uses these measurements, along with a plurality of variables associated with the first customer, to determine a wear rate. Subsequently, the wear rate is used to determine when the tire tread depth is forecasted to fall below a predetermined threshold. In other words, the wear rate can be used to forecast the remaining life of the tire before a tire change is necessary. A message can then be communicated to the first customer forecasting when the depth of the tire tread will fall below the predetermined threshold.

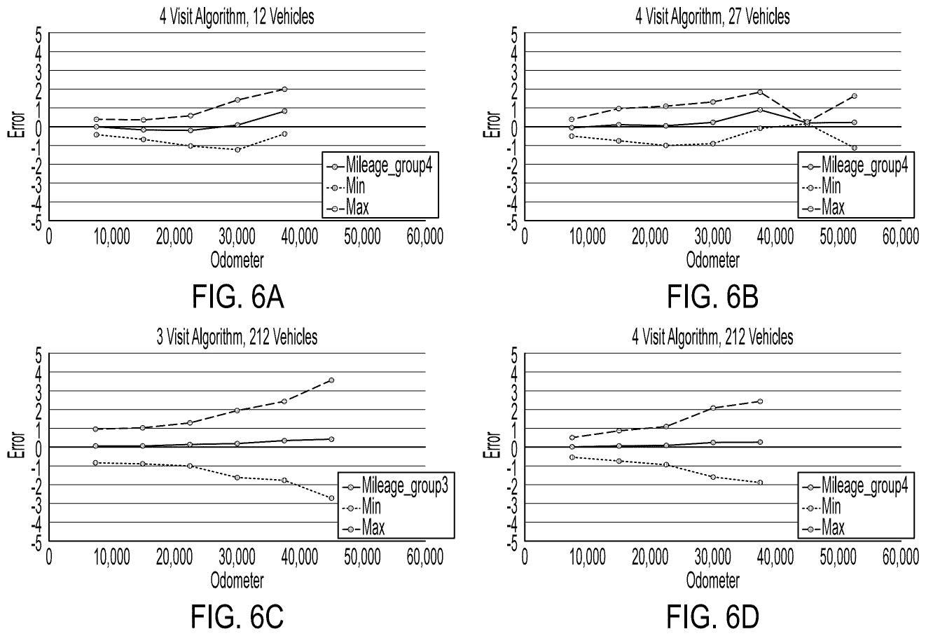

FIGS. 6A to 6D illustrate prediction error results of a system for forecasting a depth of a tire tread, according to an example embodiment of the present disclosure. In the example Figures, the y-axis reflects an error, which corresponds to 1/32 inches. While any increment of error can be used, 1/32 inches reflects the industry standard measurement increment when evaluating tire tread depth and when evaluating prediction accuracy. Further, the x-axis reflects the odometer mileage of predictions.

Namely, FIGS. 6A to 6D plot the prediction error rate of the algorithm (as described in reference to FIG. 1) against odometer readings for different number of visits and number of vehicles. For example, FIG. 6A compares the prediction error rate based on four visits for twelve different vehicles. Likewise, FIG. 6B compares the prediction error rate based on four visits for twenty-seven different vehicles; FIG. 6C compares the prediction error rate based on three visits for two-hundred and twelve different vehicles; and FIG. 6D compares the prediction error rate based on four visits for two-hundred and twelve different vehicles. As shown in FIG. 6C, using first 3 visits, the algorithm is able to project future tread depth over the next 22,500 miles of driving, with 95% of tread projections within approximately ± 1/32nd inches across two-hundred and twelve vehicles sampled.

In an example validation process for the previously disclosed algorithm, a vehicle may visit an automotive maintenance center on multiple occasions, providing several data points on tread measurement history. This information may be used as an input to the algorithm and a validation output based on actual data. For example, the first three visits may be used as inputs into the algorithm. Each visit beyond the third visit could be used to validate predictions and the plot error. Such prediction errors may follow a normal distribution. Moreover, the accuracy or precision of the algorithm may provide accurate predictions but decrease as prediction mileage increases. This trend is illustrated as more vehicles are included in the validation process. FIGS. 6A, 6B, and 6D demonstrate this improvement when comparing samples of twelve vehicles, twenty-seven vehicles, and two-hundred and twelve vehicles using the algorithm with four visits. FIG. 6C shows the equivalent results using the algorithm with three visits.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A system for forecasting a depth of a tire tread of a vehicle, comprising:
a first device configured to measure a first depth of the tire tread and a second depth of the tire tread, wherein the first depth of the tire tread and the second depth of the tire tread are associated with a first customer;
a processing unit configured to receive the first depth of the tire tread and the second depth of the tire tread, wherein the processing unit comprises an algorithm, wherein the algorithm determines a wear rate based on at least the first depth of the tire tread, the second depth of the tire tread, and a plurality of factors associated with the first customer, and wherein the processing unit is configured, based on the wear rate, to forecast when the depth of the tire tread will decrease below a predetermined threshold; and
a second device associated with the first customer, wherein the second device is configured to receive a message from the processing unit communicating an estimate of when the depth of the tire tread is forecasted to fall below the predetermined threshold.

2. The system for forecasting the depth of the tire tread of claim 1, wherein the processing unit includes storage, wherein the storage is configured to store the first depth of the tire tread and the second depth of the tire tread.

3. The system for forecasting the depth of the tire tread of claim 1, wherein the plurality of factors associated with the first customer include a first odometer reading and a second odometer reading, wherein the first odometer reading corresponds to the first depth of the tire tread and the second odometer reading corresponds to the second depth of the tire tread.

4. The system for forecasting the depth of the tire tread of claim 3, wherein the algorithm determines a correction factor based on a sub-set of the plurality of factors associated with the first customer.

5. The system for forecasting the depth of the tire tread of claim 4, wherein the correction factor and the initial wear rate correspond to a remaining useful life.

6. The system for forecasting the depth of the tire tread of claim 5, wherein the correction factor ranges from 0.85 and 1.15.

7. The system for forecasting the depth of the tire tread of claim 4, wherein the correction factor is updated when the first device measures a third depth of the tire tread.

8. The system for forecasting the depth of the tire tread of claim 4, wherein the sub-set of the plurality of factors associated with the first customer include at least one of a model of the vehicle and a year of the vehicle.

9. The system for forecasting the depth of the tire tread of claim 1, wherein the first device is an automatic tread measurement device, and wherein the automatic tread measurement device is configured to measure the first depth of the tire tread and the second depth of the tire tread when the vehicle drives over the automatic tread measurement device.

10. The system for forecasting the depth of the tire tread of claim 1, wherein the first device is a handheld device.

11. A method for forecasting a depth of a tire tread of a vehicle, comprising:
measuring a first depth of the tire tread;
measuring a second depth of the tire tread;
associating the first depth of the tire tread and the second depth of the tire tread with a first customer;
communicating the first depth of the tire tread and the second depth of the tire tread to a processing unit, wherein the processing unit includes an algorithm to determine a wear rate, and wherein the algorithm determines the wear rate based on at least the first depth of the tire tread, the second depth of the tire tread, and a plurality of factors associated with the first customer;
forecasting, based on the wear rate, when the depth of the tire tread will decrease below a predetermined threshold; and
communicating to the first customer an estimate of when the depth of the tire tread is forecasted to fall below the predetermined threshold.

12. The method for forecasting the depth of the tire tread of claim 11, further comprising storing the first depth of the tire tread and the second depth of the tire tread in storage of the processing unit.

13. The method for forecasting the depth of the tire tread of claim 11, wherein the plurality of factors associated with the first customer include a first odometer reading and a second odometer reading, wherein the first odometer reading corresponds to the first depth of the tire tread and the second odometer reading corresponds to the second depth of the tire tread.

14. The method for forecasting the depth of the tire tread of claim 13, wherein the algorithm determines a correction factor based on a sub-set of the plurality of factors associated with the first customer.

15. The method for forecasting the depth of the tire tread of claim 14, wherein the correction factor and the initial wear rate correspond to a remaining useful life.

16. The method for forecasting the depth of the tire tread of claim 15, wherein the correction factor ranges from 0.85 and 1.15.

17. The method for forecasting the depth of the tire tread of claim 14, wherein the correction factor is updated when the first device measures a third depth of the tire tread.

18. The method for forecasting the depth of the tire tread of claim 14, wherein the sub-set of the plurality of factors associated with the first customer include at least one of a model of the vehicle and a year of the vehicle.

19. The method for forecasting the depth of the tire tread of claim 11, wherein the first device is an automatic tread measurement device, and wherein the automatic tread measurement device is configured to measure the first depth of the tire tread and the second depth of the tire tread when the vehicle drives over the automatic tread measurement device.

20. The method for forecasting the depth of the tire tread of claim 19, wherein the first device is a handheld device.
